(19) United States
(12) Patent Application Publication
(10) Pub. No.: US 2011/0236729 A1
(43) Pub. Date: Sep. 29, 2011

(54) HYDROGEN CELLS OR MICROCELLS WITH A HYDROGEN GENERATOR

(76) Inventor: Alex Hr Roustaei, Villeneuve la Garenne (FR)

(21) Appl. No.: 13/132,633

(22) PCT Filed: Dec. 4, 2009
(86) PCT No.: PCT/FR2009/001382

§ 371 Date: Jun. 3, 2011

(30) Foreign Application Priority Data
Dec. 5, 2008 (FR) FR08 06821
Jan. 22, 2009 (FR) FR09 00267

(51) Int. Cl. H01M 16/00; H01M 8/06; B01J 19/00; B82Y 30/00

(52) U.S. Cl. 429/9; 429/421; 429/410; 422/239; 977/700

(57) ABSTRACT

The invention relates to a system that consists of a Hydrogen production device made up of a chamber (1-10) for hydrolyzing a metal hydride, separated by a thin membrane (1-1) superposed on a rigid grid (1-5) from at least one reservoir (1-3) containing a liquid solution for the reaction, with at least one hydride-based nanoscale element. This application is an extension and continuation of an alternate patent application with internal priority claim of a patent application No. 0806821, filed on Dec. 5, 2008; that is itself an extension of patent application No. 0806820 filed on Dec. 5, 2008; that is itself is an extension of patent application No. 0804598, file on Aug. 14, 2008; that is itself is an extension of a first invention patent application No. 0803019, filed on Jun. 2, 2008. The present application is therefore a continuation in part of the patent application No. FR0804598, file on Aug. 1, 2008 (PCT-FR/2009/000999, dated Aug. 12, 2009) that is a continuation in part of a first patent application No. FR0803019, filed on Jun. 2, 2008 (PCT-FR/2009/000622, dated May 28, 2009) which has been entirely appended for reference to and integrated into the present invention.

This application is a patent application under the PCT Pub. No.: WO/2010/081942 of International Application No.: PCT/FR2009/001382, Published on Jul. 22, 2010, with International Filing Date of Dec. 4, 2009, and domestic priority claim with the internal priority of a first application for a patent number FR0900267, filed Jan. 22, 2009. The entire application PCT/FR2009/001382 as well as FR0900267are restructured and incorporated into this new application for patent by cross-referencing.

This application is also an extension and continuation in part of an alternate patent application with internal priority claim of a first invention patent application No. 08 04598 filed on Aug. 14, 2008 (PCT-FR/2009/000999, dated Aug. 12, 2009), that is a continuation in part of a first patent application No. 0803019 filed on Jun. 2, 2008 (PCT-FR/2009/000622, dated May 28, 2009) which has been entirely appended for reference to and integrated into the present invention.

### INTRODUCTION

Historically, manufacturers of portable devices are seeking to ensure autonomy increasingly important to users. Treatment systems require more and more autonomy and are more energy intensive due to their increased computing power.

The development of techniques for the implementation of the nanoparticles is a fundamental step to obtain the expected performance in energy efficient devices.

Nomadic electricity and batteries are a key element in our daily use of portable devices. The batteries can provide electricity for a longer period in small dimensions. Hydrogen fuel cells are capable of delivering more energy into equivalent space. Currently, the most technologically advanced batteries have an energy density of smaller magnitude than a hydrogen tank of comparable size.

However, the batteries are easier to manufacture with reduced size compared to cells that require hydrogen pumps and electronic control components.

Indeed, it is not easily possible to make hydrogen fuel cells equipped with pump, pressure sensor and control electronics in sizes as small.

The invention uses a thin membrane that separates the water reservoir of the chamber containing the hydride or nanohydride for hydrogen production.

Below nanohydride is placed an electrode assembly constituting the hydrogen fuel cell Small holes in the membrane allow water molecules to pass through and reach the adjacent room containing hydrides as a vapor. Once in the room nanohydrure, water vapor reacts with the hydride to generate hydrogen, which fills the room, pushing the membrane against a fixed wall that blocks the flow of water. Hydrogen is gradually being used by the hydrogen fuel cell (which the electrodes are generally placed under the mixture of porous nanohydrure) which produces electricity. When the gas pressure (hydrogen) decreases, the membrane is loose to allow water to enter and thereby maintain the reaction that generates hydrogen.

One of the main innovative aspects of this application consists in the establishment of a couple “rigid Grid-Membrane” with holes whose axes are shifted from one relative to another. Once superimposed, the couple creates a passage (passage created between two axes) for water vapor in the initial state. The gap between these two elements is zero (stuck) when the hydrogen pressure pushes the membrane against the rigid grid, thus blocking the passage of water molecules. All the principles of gas overproduction of the buffer stage developed in the patent applications No FR0803019, FR0804598 and FR0806821 are applicable.

This technique can easily manage a production of Hydrogen on demand. The excess hydrogen before blocking water molecules is directed toward the buffer stage to the next round of arrival of water vapor on sodium borohydride through the membrane and thus manages the power spikes. It is an effective technique of production to the demand for hydrogen.

### AREAS OF USE OF THE INVENTION

The present invention provides an efficient and innovative solution for the production of electricity and energy assistance from the abundant and natural resources available to man This is a technique for producing the hydrogen by a hydrolysis system providing super-efficient solution to the problems associated with the hydrolysis technique namely control, power, energy efficiency, etc.

These new production techniques allow reuse of gases to sustain the cycle of hydrolysis beyond the additional work which involves the production of electricity using fuel cells. The fields of use covering all interactive systems including mobile, portable or handheld requiring more energy than existing batteries of the same size can provide or any environment requiring energy to operate stationary or mobile. The application areas include among others, Cell Phones, Laptops, Camera, Digital Cameras, CD and DVD players, music players and portable radios, Games, Battery chargers in support, GPS, Medical Devices, Accessories chargers, etc.

The present invention therefore relates to the production of devices for generating electricity using portable hydrogen fuel cells. In particular, the production of hydrogen can be produced by a hydrolysis reaction as a hydride borohydride.

Based on the Cycle Water-Gas-Water, a “push-gas membrane” drives (leads) the produced hydrogen, to a fuel cell and catalysis from the air generates electricity. The produced water is recycled into the departure reservoir (cartridge or tank).

This invention finds particular application as a generator for the hydrogen batteries of type PEMFC “Proton Exchange Membrane Fuel Cells”.

More particularly, the present invention relates to hydrogen fuel cells for electric devices and portable electrical or miniature electronic components, integrated or implanted in bodies, that is to say devices requiring electrical power are low and/or long life time.

This invention may however be applied for supplying hydrogen for hydrogen fuel cells in higher powers or assistance in stationary units for example (i.e., invention can serve to support/assist batteries in vehicle/electric cars for longer drives).

This application is an extension and a later patent application with claiming internal priority of an application for patent number FR0806821 filed on, Dec. 5, 2008, itself an extension and a later patent application with claim internal priority of a first application for a patent number FR0806820 filed on, Dec. 5, 2008, which is an extension and a later patent application with claiming internal priority of a first application for a patent number FR0804598, filed, Aug. 14, 2008, itself an extension and a later patent application with claiming internal priority of a first application for a patent number FR0803019, filed, Jun. 2, 2008 that are incorporated in their entirety by referencing to the present invention.

### STATE OF THE ART AND PRIOR ART

The recent development of new methods of achieving fuel cell or micro fuel cells (micro cap) does not rely on simply reducing the size of a conventional fuel cell, but rather on the use of type processes thin is a thin film of material deposited on another material, called “substrate”. The goal is to give special properties to the surface of the work-piece while benefiting from massive properties of the substrate.

Micro fuel cells today are about 50×30−40 mm², and are capable of maintaining the flow of a video broadcast on a mobile for more than 13 consecutive hours with only 10 ml (milli-liter) of methanol. These devices typically use a quoted Li-polymer complementary to bear the pikes power.

Current state of the art is also based on the simultaneous use of skills in electrochemistry and micro technology that has developed this technology based on silicon wafers which are made of “smart” fuel cells. The energy storage device is a disposable cartridge that can produce gas “on demand” hydrogen.

The patent applications US2001/045364 and WO/2002/30810 describe hydrogen generators in which the hydrolysis reactions are controlled imprecisely, because the reactants are contacted in many ways, with reactions are triggered and occur all nearly simultaneously at a large exchange surface reaction. The activation of the reactants in liquid and solid state (heterogeneous reaction) is difficult to control because it requires mechanisms of water diffusion into hydrides or nanoborohydrures.

Moreover, none of the techniques developed in the patent applications:

WO2007060369; WO/2008/022346, WO/2008/106722, WO/2006/035210, WO/2006/091227, WO/2006/101214, WO/2006/127657, WO/2007/008893, WO/2007/050447, WO/2007/050448, WO/2007/052607, WO/2007/095514, WO/2008/017793, WO/2008/057921; allow to consider miniaturization solutions based on hydrogen for a realization of small batteries or a miniaturized production of electricity with duration of operation, power or fuel efficiency comparable to current disposable batteries or rechargeable batteries.

To date the conversion of methanol is potentially as interesting as the use of solutions based on hydrogen or standard batteries. But this is often based on older technology regardless of nanotechnology.

In the case of a DMFC (Direct Methanol Fuel Cell), the fuel is oxidized by a catalyst, forming carbon dioxide, protons and electrons. The protons and electrons take different routes each to opposite sides of the electrodes to combine and generate (produce) the water in one hand and the electrical power on the other.

In the case of methanol, CO2 with water vapor and methanol are directed and collected inside the cell, decreasing the concentration and thus the power output. The existence of the pumps can remove impurities, but it needs the space.

Prior art as used by researchers at the National Tsing Hua University “uses techniques and systems of waste disposal but requires more space than the dimensions (Direct Methanol Fuel Cell micro) DMFCs micro. These systems are acting as a filter which receives gas and steam in a few easy steps.

Remember that the application No. FR0803019, No. FR0804598 and FR0806821 filed respectively on Jun. 2, Aug. 14 and Dec. 5, 2008 mention the following:

“. . . Knowing that; hydrogen can be used as a fuel to move a vehicle”.

The first supplement to the application No. FR0803019 would be to dispose (have) energy at will and thus to have a means of storing hydrogen. Indeed, storage of surplus energy as hydrogen becomes a “plus” that will provide greater comfort in automotive applications. It is therefore possible to store all or part of the excess hydrogen produced by the invention No. 08 03019 in a storage system. We envision this cryogenic storage units or nano hydrides because the performance of energy storage in hydrides and hydride nano has increased in recent years.

Hydrogen fuel cells may represent a source of clean energy and alternative to the combustion of hydrocarbons, both for automobiles than for handheld devices. A hydrogen fuel cell is a cell in which electricity is generated by hydrogen on an electrode, coupled with the reduction of an oxidant such as oxygen from the air, on the other electrode.

The acceleration of the oxidation reaction of hydrogen is often produced using a catalyst which typically contains a nano element of the type NiFe. We have shown in the patent application No. FR0803019 and also in FR0806821, that the existence of a fluidized bed with nano particles significantly increases the efficiency in this reaction.

However, in disposable hydrogen fuel cells, technology choices can move towards liquid solutions directly oxidized at the anode of the battery or to fuels, liquid or solid, capable of generating hydrogen “on demand” as described in the application FR0803019 and FR0806821. This is reflected by the fact that practically the amount of hydrogen generated is equivalent to the amount of hydrogen consumed by the cell and (or) to absorb the pick powers of the demands.

In the known methods, we can identify one mode of production of hydrogen which is to hydrolyze borohydrides/nanoborohydrures presenting as a solid (or others), such as sodium borohydride or borohydride (short for sodium tetrahydroborate NaBH4) made a chemical that contains a large amount of hydrogen and is very efficient reaction for hydrogen production especially in the form of nano particles.

Generally, when NaBH4 is contacted with a catalyst material in solid with aqueous vapor form, a reaction produces hydrogen with sodium metaborate is recycled again borohydride sodium.

The chemical reaction is the following formula:

NaBH4+2H2O>4H2+Heat+NaBO2

Generally, the reaction of hydrolysis of sodium borohydride is effected according to the formula thus:

M(BH4),,+2nH2O→M[B(OH)4]n+4nH2

where M is an alkali or alkaline earth metal and “n” a positive integer equal to the number of valence electrons of the element “M”. If “M” is sodium (Na), then the number “n” equals “1”. The reaction formula is simplified in this case the form:

NaBH4+2H2O→NaB(OH)4+4H2.

Note that “M” may be constituted by potassium (K), lithium (Li) or another appropriate item.

In conclusion, it is evident that the hydrolysis reaction of an element involves borohydride reagent and innocuous, non-toxic and non-polluting, unlike the reactions in the DMFC batteries or FAFC (short for “Formic Acid Fuel Cell”), respectively using methanol or formic acid as fuel instead of hydrogen.

Certain units of the existing art are implementing solid borohydrides, for example in the divided state, that is to say, in powder form. The technique used to improve the efficiency of the hydrolysis reaction is relatively difficult to implement.

The major problem is to control the reaction between solid borohydride and an aqueous solution and thus the flow of hydrogen generated.

According to some particular realization cited in particular the patent application WO/2007/060369, the hydrogen generator has a plurality of envelopes, similar geometry allows more control of the hydrolysis reaction by multiplying the water inlets controlled flow within the reactor but increases the size and weight of the generator.

The hydride or nanohydrures can be selected as a pellet, rod, pill or powder and is often in the group consisting of sodium tetrahydroborate (NaBH4), magnesium tetrahydroborate (Mg(BH4)2), borohydride lithium hydride battery-aluminum hydride, sodium and/or calcium and lithium hydride (LiH). These three compounds give residue clean reactions. They have a strong capacity to generate hydrogen. Sodium tetrahydroborate NaBH4 is also known to be as advantageous as easy and inexpensive to produce (the hydride is selected from the group consisting sometimes LiBH4, Al (BH4) 3, Be (BH4) 2, MgH 2, CaH 2, Ca (AlH4) 2, Zr (BH4) 3, Ca (BH4) 2, NaAlH 4, KBH 4, LiAlH 4). The diagram of the reaction 2 Al+6 OH→>Al2O3+3H2 can also treat the aluminum or aluminum alloy as a consumable material base, because the reaction has the advantage of lowering the pH by consuming hydroxide ions, which slow down the main reaction of hydrolysis of the hydride.

Typically, the consumable material chosen consists of a metal corroding or degrading organic material in the presence of an aqueous basic solution. Thus, during the hydrolysis of the hydride, this material is consumed due to the concomitant generation of hydroxide ions.

Hence the interest to be able to recycle the byproducts created during the hydrolysis.

Among the selected organic material we can include polyamides, polycarbonates, PET (polyethylene terephthalate), PBT (polybutylene terephthalate), polyester and PVDF (polyvinylidene fluoride).

It is important to note that the introduction into the reactor of a catalyst in the form of a salt (sodium chloride) dissolved in water or in the form of nanoparticles distributed in the solid hydride (the same group hydride comprising tetrahydroborate) increases the yield of reaction and adding it directly into one of the reagents mentioned above can avoid its specific introduction into the reactor during operation. This simplifies the implementation of the generator. The quantities of hydride/hydride nano and water within the reactor are selected and sized to produce a flow of hydrogen determined by the application.

Liquid solutions may be causing the reaction, for example, water, acid, alcohol, and/or a mixture of appropriate solutions.

In addition, the component of the catalyst for this reaction is often selected from the group comprising gold (Au), silver (Ag), platinum (Pt), ruthenium (Ru), cobalt (Co), palladium (Pd), nickel (Ni), iron (Fe), manganese (Mn), rhenium (Re), rhodium (Rh), vanadium (V), cerium (Ce) or titanium (Ti) When one or more of these metals is/are used to form the catalyst particles,

Note that the prior art often to get a steady flow of hydrogen, using streamers hydride elongated and orthogonal section of constant area. These hydrides are generally mounted on porous silicon. The shape of the hydride in its envelope is frequently used as a support for moving the seat of the hydrolysis reaction. This shape advantageously replaced by the phonograph silicone layer in the present invention allows a progressive hydrolysis of the hydride and increases the lifetime of the product while reducing dramatically the size and dimensions.

### ADVANTAGES OF THE INVENTION

The present invention seeks to overcome the disadvantages of hydrolyser and existing hydrogen fuel cells and aims to provide a clean energy source capable of supplying electricity or hydrogen for mobile system.

One advantage of the present invention is the introduction of a thin membrane that separates the water reservoir of the chamber containing the hydride or metal nano hydrides.

Another advantage of this invention is that for very small sizes of batteries, 3×10×2 mm3 is the surface tension (not gravity) that controls the flow of water through the system. This means that the battery can operate in vertical movements, horizontal or rotary. This characteristic makes it ideal for our portable devices.

Another advantage of the present invention is its lack of power consuming electricity.

A great advantage of this invention is its ability to be disposable or rechargeable as a source of clean energy and alternative battery current without the need for recycling.

Another advantage of the present invention is its ability to be integrated into a chip or mounted on individual components or thumbnails easily be implanted with bio-organs or organs within the body easily accessible.

Another advantage of the present invention is its ability to serve as food assistance for starting a system (self start) and to support (or to assist) during the current peaks in energy-intensive applications or nanotic electrolyzers.

It is one of the advantages of this invention to use a membrane as a filter outlet for unwanted items for disposal.

Yet, there is another advantage of this invention is to control the reaction of borohydride (borohydride or nano) solid (or others) and the aqueous solution and the hydrogen flow generated by simple displacement of the membrane of the couple “rigid grid-membrane” above.

Another advantage of the present invention is that the byproducts of the reaction causing frequent blockage of the water supply pipeline (the membrane) in the reactor chamber containing the nano-solid borohydride and can be removed by a simple recycling avoiding the addition of heavy equipment and expensive solving that problem. This is essential for rechargeable batteries.

Additional advantage of the present invention is to replace the graphite used in batteries as a base material on the negative electrode with a new, porous silicon in 3D, made from silica and fluorite hydrogen.

Furthermore, its applications do not take into account aspects of gravity upon the use of its battery recycling movement or reaction by-products frequently causing obstruction of the pipe for conveying water to the membrane.

We note that the cycle water-gas-water is an effective way with the ability to offer prospects of high autonomy for laptops and mobile phones. This cycle is also feasible with gas methanol.

This invention is also a very appropriate use of fuel cells or hydrogen cells, as it does not need the extra power to function.

The advantages of the present invention are among others to provide a hydrogen generator and a disposable battery or rechargeable battery that overcome all the disadvantages of the prior art.

### DESCRIPTION OF THE INVENTION

The invention relates to a generator of energy assistance or alone with a high efficiency gas or electricity demand and a simultaneous production of energy needs.

The present invention therefore relates to a device for generating hydrogen by hydrolysis of a hydride to better control the production and flow of hydrogen for energy production, particularly as nomadic.

The present invention thus relates to a device, generating electricity at the request including the membrane reactor and flow control of hydrogen without the use of extra power supply to start to function (To deliver electricity. This is equivalent to a “Self Start” function because the electricity is always available).

Understanding of this application is simplified by the following facts:

According to the invention, the introduction of a thin membrane, superimposed below a rigid grid, which separates the water reservoir, the chamber containing the hydride or metal nano hydrides.

Below metal nano hydride is located:
A residue absorption filter and a drying film.
A buffer gas space, a pushing gas film.
A membrane filter to capture all by-products of reaction and
A set of electrodes-substrate, forming the hydrogen fuel cell.

Small holes in the membrane allow water molecules passing through the holes in the rigid grid of the cross and reach the adjacent room of hydrolysis, as a vapor.

Once in the nanohydrures' chamber, water vapor reacts with it to generate hydrogen, which fills the chamber, pushing the diaphragm against the fixed wall of the rigid grid. This blocks the flow of water into the inter grid-membrane.

Hydrogen is gradually being used by the hydrogen fuel cell (electrodes placed on the mixture of porous nanohydrure) which produces electricity.

When the hydrogen gas pressure decreases, the membrane is loose to allow the water to go through and thereby maintain the reaction and the generation of hydrogen.

Another important innovation consists in a double wall “rigid grid-Membrane” with the axes of holes offset. Once stacked, they create them, a passage for water vapor in the initial state.

This gap is zero when the hydrogen pressure pushes the membrane against the rigid grid and blocks water molecules and prevents them from reaching the sodium metaborate.

All the principles of gas overproduction for the buffer stage, in the patent No. FR0806821 are applicable in this new application. This technique can easily manage a production of Hydrogen on demand. The excess hydrogen before blocking water molecules is directed toward the buffer stage for the next round of arrival of water vapor on sodium borohydride through the membrane. It is an effective technique of production to the demand for hydrogen.

A fuel cell is placed below the set and is placed on a porous silicon substrate (the principle of hydrogen fuel cell is described in patent applications number FR0803019 and FR08 06821).

In this invention a double wall (chamber) to capture waste byproducts of reaction which frequently causes obstruction of the pipe for conveying water into the chamber reactor (membrane) thereby altering the kinetics of the reaction and therefore likely to fluctuate depending on the importance of this obstruction of the water supply. To achieve this objective, a Teflon membrane or treated with a substance that repels-Water, provided micro hole, allows the gas to evacuate the chamber.

At the same time the hydrogen and water vapor condenses on the surface around the holes. This condensed liquid stream passes through the holes 5 millimeters to a collection tank.

A treated surface repels water pushes with his ardor condensed into the microphone shell starting from the exit point of water drops. The water is then recycled to start a new cycle.

Hydrides or nano hydrides are advantageously placed in phonograph silicon layer allowing a homogeneous production of hydrogen.

To facilitate understanding of the innovative aspects of this application, we will describe below some basic experiments related to the invention:
Indeed, for the production of hydrogen, our experiment used a reaction on the metal hydride LiAlH and water vapor through a membrane that controls the flow of water vapor on the basis of the pressure of hydrogen. The hydrogen produced through a wall to reach nanoporous silicon membrane electrode assembly of a hydrogen fuel cell.
It should be noted that each element of the periodic table (except for noble gases) forms at least one hydride.
These materials can be classified into three categories by their nature of “bonding” (“Nature of surface melting”), that is to say;
   Saline hydrides, which have a very significant ionic character,
   Covalent hydrides, including hydrocarbons and many other compound, and
   Interstitial hydrides form or Nanot porous and can be described as having ties (bonding) of metal.

The first achievements in the laboratory generate 0.7 volts with a current of 1 milliamp for a period of 30 hours before the water finally and that for an area of 9 mm 3.

However achievements using nano technology have achieved a current density of 12.5 mW/cm², which is 10 times higher for a conventional hydrogen fuel cell.

The realization and characterization of high performance battery or Super Miniature Battery was compared to solutions produced by the direct application of the gas with fuel cells (microDMFC) operating at room temperature under a regulated flow and forced entry with rate<10 ul/min (micro liter/minute), using the technique of silicon Microsystems.

The output power measured at room temperature was 12.5 mW cm-2 with a flow of 5.52 ul/min for a fuel cell with an area of 0.3 cm2 (This corresponds to an efficiency of fuel used by 14.1% 300 K). With a lower flux of 38 ul/min, the efficiency of fuel increases to 20.1% while the power density drops to 4.3 mW/cm².

The study shows that the optimal power density can be achieved at a flow of <10 u.l/min by:
A reduction of surface fuel cell and
A reduction in thickness (cross section) of the micro grooves (or micro channel)

The study also highlight that we can reach an efficiency of fuel consumption at very low flows.

The entry of fuel (methanol) for the anode and an oxidant (air) for the cathode was made through a network of micro-fluidics (micron scale) and micro-channels designed for gas, serpentine compact (by using the technique of silicon Microsystems).

The replacement of fuel per couple hydride-water vapor with a fluidized bed catalyst type of nanohydrures produces a power output measured at room temperature was 25 mW cm−2 with a flow of 5.52 ul/min for hydrogen fuel cell having the same area of 0.3 cm2 (This corresponds to an efficiency of fuel used by 30% at 300 K). With the lower flows of 1.4 ul/min, effective system used to increase 45.1% while the power density drops to 4.3 mW/cm².

We had to ensure the compatibility of the fuel cell with other silicon-based technologies in contact with the parties and microelectronic systems, microphones and nanoelectromechanical (MEMS/NEMS).

### BRIEF DESCRIPTION OF FIGURES

All figures describe various points of the system through the FIGS. 1 to 4, which are schematic and detailed representation of a system comprising a fuel cell for powering a portable electronic device.

FIG. 1-a represents the assembly of the micropool water and the couple screen-membrane open to vaporization of water molecules on the nanohydrures layer. Hydrogen gas is then in production.

FIG. 1-b, represents the assembly of the micropool water and the couple screen-membrane in the closed position blocking the vaporization of water molecules on the nanohydrures layer. Hydrogen gas pushes the membrane and blocks the arrival of water vapor as the hydrogen produced is not consumed.

FIG. 1-c, represents the assembly of the micropool water and the couple screen-membrane, the hydrolysis chamber, the nanohydrures layer and membrane of by-products filtration issued of reaction.

FIG. 2-a represents the assembly of the micropool water and the couple screen-membrane, the hydrolysis chamber, the nanohydrures layer and a variant of the membrane by-product filter of the reaction increasing energy efficiency.

FIG. 2-b, represents the assembly of the micropool water and the couple screen-membrane, the hydrolysis chamber, the nanohydrures layer and a variant of the membrane by-products filtration of catalyst reaction.

FIG. 2-c, represents the assembly of the micropool water and the couple screen-membrane, the hydrolysis chamber, the nanohydrures layer and a variant of the by-product membrane filter of the reaction serving as a catalyst with the buffer floor (stage) for the gas on the electrode.

FIG. 3-a, represents the assembly of the micropool water and the couple screen-membrane, the hydrolysis chamber, nanohydrures the layer and a possible variant of the by-products filtration membrane of reaction as a catalyst with buffer stage for the gas on the anode electrode assembly of the fuel cell (or hydrogen fuel cell).

FIG. 3-b represents the assembly of the micropool water and the couple screen-membrane, the hydrolysis chamber, nanohydrures layer and a filtration membrane with the buffer stage of hydrogen on the anode of the hydrogen fuel cell. The hole (FIG. 3-10) is the arrival of the AIR on the cathode of the fuel cell (stack) to enable the system to function.

FIG. 3-c, represents the assembly of the micropool water and the couple screen-membrane, the hydrolysis chamber, nanohydrures layer and a membrane filter with the buffer stage of hydrogen on the anode of the hydrogen fuel cell. The arrival of the AIR on the surface of the cathode of the fuel cell as well as a reduction of fuel cell sections (thickness) of micro grooves or micro-channels is also shown.

FIG. 4 shows the assembly of the elements of a disposable or rechargeable battery equipped with its terminal connectors and contacts as well as charging holes and air inlet showing the considerable reduction in size of the battery of the present invention.

### DETAILED DESCRIPTION OF THE INVENTION WITH FIGURES

For a complete understanding of the present invention, we are going to detail all of the figures describing the various points of the system.

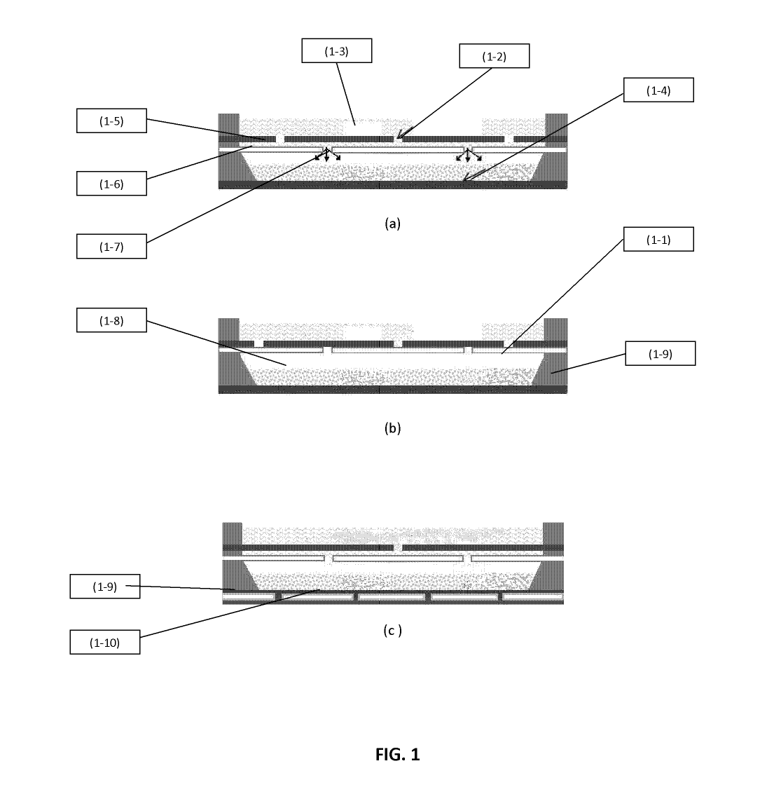

According to the invention, as shown in FIG. 1 through the introduction of a thin membrane 1-1 (FIG. 1b), superimposed below a rigid grid 1-5 (FIG. 1a), which separates the water tank 1-3 (FIG. 1a), the chamber containing the hydride or metal nano hydride 1-10 (FIG. 1c).

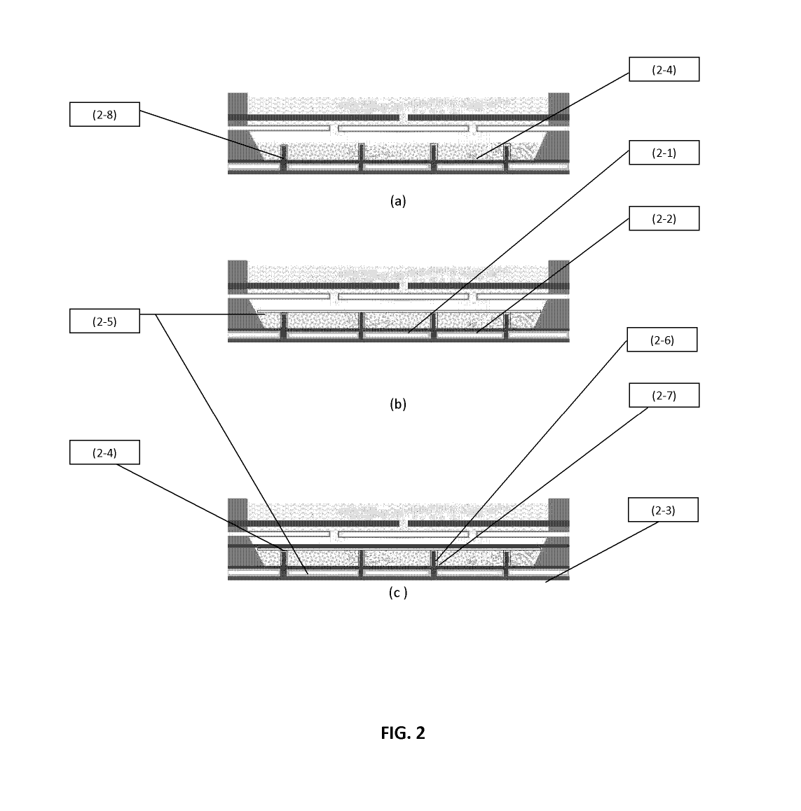

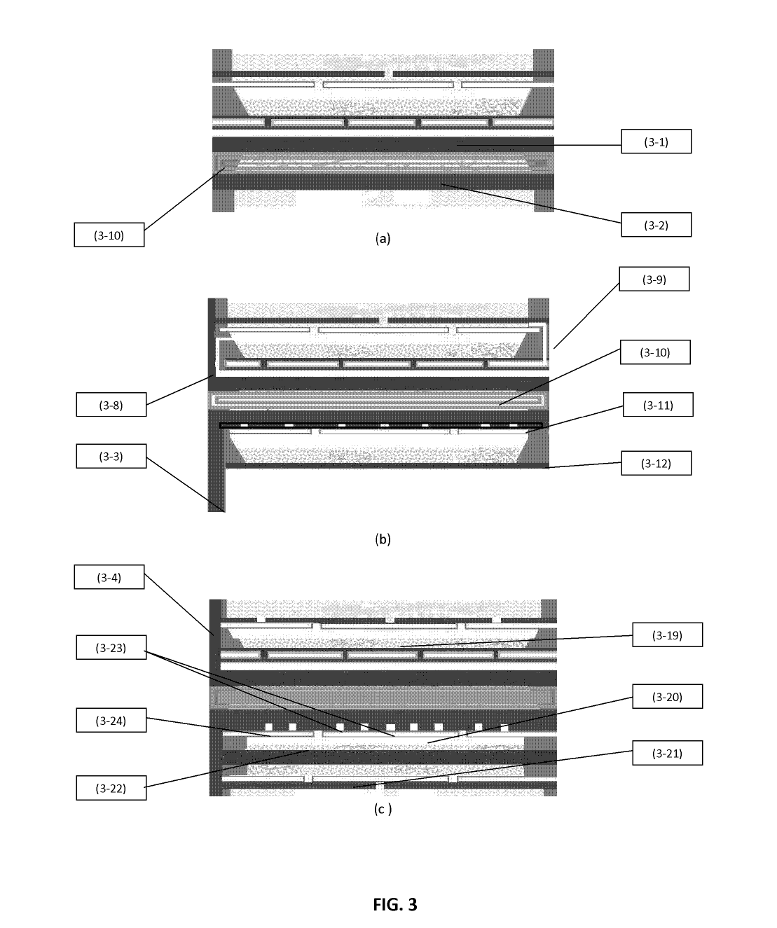

Below hydrides or nano metal hydrides is an absorption filter residues 2-4 (FIG. 2a), a film by drying 2-1 (FIG. 2b), A buffer gas 2-2 (FIG. 2b), a thin film pushes the gas 2-4 (2C), and a membrane filter by-products of reaction 2-3 (2C). Electrode assemblies 3-1 (FIG. 3a) and 3-2 (FIG. 3a), forming hydrogen fuel cell 3-10 (FIG. 3b). Note that the stack 3-10 (FIG. 3b), may consist of as many basic module is necessary to obtain the desired voltage.

Small holes in the membrane 1-7 (FIG. 1a), allow the water molecules, passing through holes 1-2 (FIG. 1a) of the rigid grid 1-5 (FIG. 1a) to cross the membrane 1-1 (FIG. 1b), and reach the adjacent room hydrolysis 1-8 (FIG. 1b) as a vapor. Once in the room hydrides, water vapor reacts with it to generate hydrogen, which fills the room, pushing the membrane against a fixed wall of the rigid grid 1-5 (FIG. 1a). This simple action stops the flow of water in the space of the corridor type 1-6 (FIG. 1a).

Hydrogen is gradually being used by the hydrogen fuel cell 3-10 (FIG. 3b). For a better distribution of gas, hydrides and/or nanohydrures 1-10 (FIG. 1c) generating the hydrogen, are placed in grooves provided for this purpose on a layer of porous silicon thin type 1-4 (FIG. 1a).

The increase of the reaction is carried out by an increase in hydrolysis surface using phonograph silicone layer and catalysts in a fluidized bed (increase the 3D effect of nano particles). It replaces the form of hydride in its envelope which is frequently used to support the movement of the seat of the hydrolysis reaction.

When the hydrogen gas pressure decreases, the membrane 1-1 (FIG. 1b) is loose to allow water to enter through holes 1-7 (FIG. 1a) released by the gap 1-6 (FIG. 1a) and thereby maintain the reaction and the generation of hydrogen. Everything is done in a container 1-9 (FIG. 1b) of varying shape and adapted (properly) to a given application.

Another important innovation consists in a double wall “rigid grid-Membrane” with axes offset holes 1-7 (FIG. 1a). Once stacked, they create them, a passage for water vapor in the initial state 1-6 (FIG. 1a). This gap is zero when the hydrogen pressure pushes the membrane against the rigid grid and blocks water molecules, preventing them from reaching the sodium metaborate 1-10 (FIG. 1c).

All the principles of gas overproduction for the buffer stage 2-2 (FIG. 2b), developed in patent applications No. FR0803019 and FR0806 821 are applicable in this new application. These techniques can easily manage an on demand production of Hydrogen.

The excess hydrogen before blocking water molecules is directed toward the buffer stage 2-2 (FIG. 2b), for the next round of the arrival of steam on hydrides or nano hydrides through the membrane 1-1 (FIG. 1b).

This technique is a simple and efficient way of on demand production of gas and is particularly advantageous for producing hydrogen on demand.

Note that the principle of hydrogen fuel cells 3-10 (FIG. 3b) is well known at this time. It is described in the patent applications number FR0803019 and is part of this application in its simplest form, is to say comprising an electrolyte, an anode and cathode, whose oxidant is oxygen (O2), and the reductor of hydrogen (H2) produced by hydrolysis, characterized by comprising a device as described in this application to generate hydrogen by hydrolyzing hydride as described above.

Battery 3-10 (FIG. 3b) is generally placed below hydride's compound (or wrapped) on a porous silicon substrate.

The present invention uses a double wall (or room) to capture residues 2-5 (FIGS. 2b and 2c) for the by-products of reaction caused. This double wall prevents clogging of the membrane 1-1 (FIG. 1b), led to water in the reactor chamber containing the solid or nanotics powdered hydrides 1-10 (FIG. 1c), and thus prevents the modified the kinetics of the reaction.

The double membrane reacts as a filter which receives gas and steam and eliminates unwanted by-products in a few simple steps.

A film 2-5 (FIG. 2b), the type Teflon Treaty allows the gas to evacuate the chamber while at the same time the hydrogen and water vapor condenses on the surface around the holes 2-5 (2C). The condense passes through the passages 2-6 (2C) serpentine.

A surface treated 2-7 (2C), grows with fervor, its condensed, to the micro tank starting 3-9 (FIG. 3b) and this along the wall (or adjacent channel) of the anode 3-8 (FIG. 3b).

A serpentine structure 2-8 (FIG. 2a) the substrate housing the hydrides or nano hydride can be treated with a catalyst increases the reaction in the production of hydrogen.

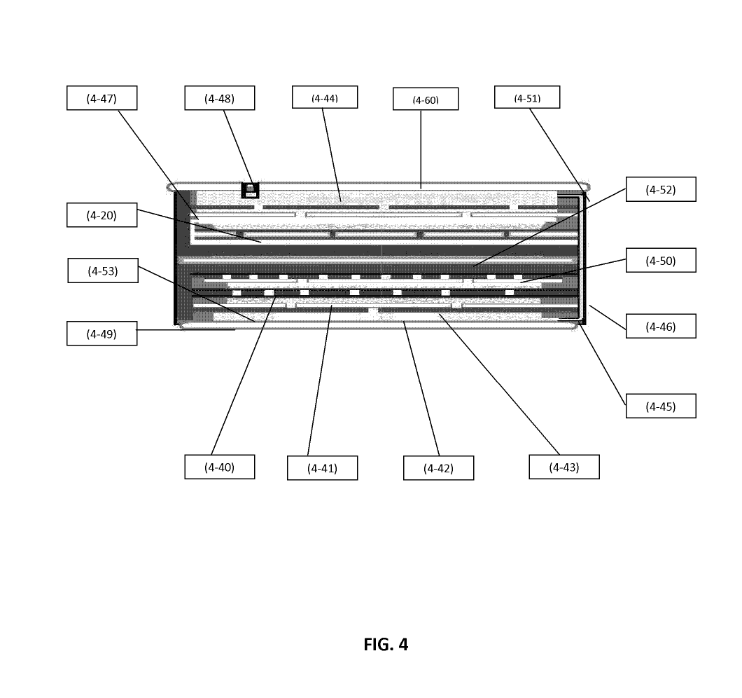

The end-connections (contact pads or connecting terminals) of the battery are connected to the battery 3-10 (FIG. 3b) by drivers (flat wires) 3-3 (FIGS. 3b) and 3-4 (FIG. 3c).

The passage of air through the port 3-11 (FIG. 3b) on the cathode 3-2 (FIG. 3b) Battery 3-10 (FIG. 3b), produces water. Treated Teflon 3-20 (FIG. 3c) with a substance “Repel-Water” equipped with about 100 to 110×45 to 55 micron-diameter holes, allows the gas to evacuate the chamber. The air circulates through the coil structure 3-23 (FIG. 3c) and exits through the exhaust vent 3-24 (FIG. 3c).

This condensed liquid stream passes through the holes 4-41 (FIG. 4) of 5 millimeters to a collection tank 4-42 (FIG. 4).

A 4-43 treated surface (FIG. 4) to “Repel-Water”, grows with great fervor, these condensed to the micro tank starting 1-3 (FIG. 1a) and this, along the wall (or per channel) 4-46 (FIG. 4) from the exit point of water tastes 4-45 (FIG. 4). The water is then recycled to start a new cycle in the micro-reservoir tank 4-44 (FIG. 4).

The orifice 4-48 (FIG. 4) is used to recharge the battery liquid solution causes the reaction and can be, for example, water, acid, alcohol, and/or a mixture of the aforementioned solutions for rechargeable batteries versions.

The water produced by hydrogen fuel cells 3-10 (FIG. 3) is collected and directed towards the tank 4-44 (FIG. 4) through the 4-51 (FIG. 4). Similarly, rechargeable or disposable caps for micro-batteries (capsule for supplying water by injecting a fraction of it) can also be inserted into predetermined units.

The hole 4-47 (FIG. 4) is used to recharge the battery in form of hydride or nano hydride solution or powder for rechargeable batteries and recyclable models.

The contact pad 4-60 (FIG. 4) is the anode of the battery while the contact pad 4-49 (FIG. 4) is the cathode of the battery. The orifice 4-50 (FIG. 4) is used to supply air to the stack. Return gas as a buffer 4-20 (FIG. 4) is partly embedded in the substrate.

Note that the separation film 4-51 (FIG. 4) is used to separate various components of the cell and the cathode 4-52 (FIG. 4) of the battery is connected to the chip output through a super-capacitor 4-53 (FIG. 4) Cathode between 4-52 (FIG. 4) and anode 4-60, calls for the absorption current (pick of current).

A variant of the present invention includes voltage converters of high efficiency DC/DC and DC/AC provided an output voltage different from the fuel cell, thereby adjusting the required voltage.

By its structure, the device for generating energy described in the present invention can be characterized by a plurality of envelopes, as having similar or dissimilar geometries and replied or distributed on a support and/or form whatsoever.

Similarly, the outer envelope and/or physical appearance may be apparent in the shape of a cylinder, disc, cube or cone, flat card, circular or polygonal base.

The cycle Water(or/liquid)-Gas-water(or/liquid) is complete. This cycle is achievable with a methanol gas which is extracted from the previous step or with hydrogen. Liquid solutions may be causing the reaction as well; water, acid, alcohol, and/or a mixture of the aforementioned solutions.

It is important to note that the present invention is more clearly evidenced by the description of specific embodiments as described. Nevertheless, the object of the invention is not limited to these embodiments described because other embodiments of the invention are possible and can easily be achieved by extrapolation.

1. (canceled)

2. (canceled)

3. (canceled)

4. (canceled)

5. (canceled)

6. (canceled)

7. (canceled)

8. (canceled)

9. (canceled)

10. (canceled)

11. An optimized system for producing hydrogen comprising;
a metal hydride hydrolysis chamber, separated by a thin membrane overlying a rigid grid of at least one reservoir containing a liquid solution for reaction with the at least one nano-scale materials based on compounds hydrides or nano-scale tubes, such materials including nano metals from 1 to 50 nm, called nano elements.

12. The system of claim 11 wherein;
the flow of generated gas is controlled by a pair consisting of a rigid wall and membrane.

13. The system of claim 12 wherein;
an optimized system for generating electricity having a fuel cell comprises an electrolyte, an anode and a cathode, in which the oxidant is oxygen (O2), and the control of hydrogen (H2) produced by hydrolysis.

14. The system for generating electricity according to claim 13, further comprising;
at least a capture filter for waste by-products of the reaction caused in the reactor chamber.

15. A system as described in claim 13, further comprising;
micro battery type with a sandwich or stacked structure, compact and/or having an mean of loading of the liquid solution to the reaction and/or hydrides to make the device Rechargeable or Recyclable.

16. A system as described in claim 15 further comprising;
a DC/DC or DC/AC and/or super capacitor, where the capacitor is used to absorb spikes in requests of additional power.

17. A system as described in claim 16 further comprising;
at least one rechargeable or disposable capsule containing water based solution, gas or a location for an entry capsule inserted.

18. A system as described in claim 12 wherein;
the increase of the reaction is carried out by an increase in surface hydrolysis using microgroove silicone layers and catalysts in a fluidized bed to increase the effect of nano particles in a three dimensional environment.

19. A system for generating electricity according to at least one of the claims 15 to 18 characterized in that the outer envelope or physical appearance is in the shape of a cylinder, disc, flat card, cube or cone, a circular base or polygonal.

20. A system for generating energy according to at least one of the claims 15 to 18 characterized in that it comprises;
a plurality of envelopes with geometries similar form or not, and spread on a support and/or form whatsoever.

21. An optimized system for generating electricity based on the Water-Gas-Water cycle comprising;
hydrogen based self start system.

22. An optimized system for generating electricity based on the Liquid-Gas-Liquid cycle comprising;
Hydrogen based self start system to provide on-demand electricity in assistance or as a source in mobile products or electric vehicles.
